(19) United States
(12) Patent Application Publication
(10) Pub. No.: US 2017/0053553 A1
(43) Pub. Date: Feb. 23, 2017

(54) ACTIVITY MONITORING SYSTEM AND METHOD FOR MEASURING CALORIE CONSUMPTION THEREOF

(71) Applicant: ELECTRONICS AND TELECOMMUNICATIONS RESEARCH INSTITUTE, Daejeon (KR)

(72) Inventors: YongWon JANG, Daejeon (KR); Seunghwan KIM, Daejeon (KR)

(21) Appl. No.: 15/242,038

(22) Filed: Aug. 19, 2016

(30) Foreign Application Priority Data
Aug. 21, 2015 (KR) 10-2015-0118194

(51) Int. Cl. G09B 19/00; G06N 3/08; G09B 5/12

(52) U.S. Cl. CPC G09B 19/0092; G09B 5/125; G06N 3/08

(57) ABSTRACT

Provided is a method for measuring calorie consumption of an activity monitoring system, includes collecting calorie consumption data from at least one sensor worn by a user, classifying an activity type of the user corresponding to the calorie consumption data, classifying an intensity of the activity type and calculating calorie consumption corresponding to the intensity of the activity type.

### CROSS-REFERENCE TO RELATED APPLICATION

This U.S. non-provisional patent application claims priority under 35 U.S.C. §119 of Korean Patent Application No. 10-2015-0118194, filed on Aug. 21, 2015, the entire contents of which are hereby incorporated by reference.

### BACKGROUND

The present disclosure herein relates to an activity monitoring system and a method for measuring calorie consumption thereof.

A technique for estimating calorie consumption by using a signal of a physical sensor such as an acceleration sensor or a gyro sensor is well-known, and devices using the technique are widely spread in the market. Most of the devices are standalone devices in a wearable device type such as a bracelet or a watch around a wrist, and have beautiful designs and high convenience. However, when calorie consumption is estimated by using the device, accuracy may be lowered. For example, when a person wears the device on his/her wrist and drives a car or remains seated to continuously move his/her hand, the device may perform an overmeasure.

In addition, since calorie consumption of human beings differs greatly for each person, a perfectly accurate measurement is not possible. When measuring the calorie consumption by using an indirect calorie meter or the like, even if characteristics of the measured acceleration are similar, there are many cases where the calorie consumption differs greatly for each person. Accordingly, there is a limitation in accuracy to infer the calorie consumption by using an accelerometer or the like. In addition, some devices estimate the calorie consumption by connecting magnitude and frequency of an acceleration waveform to activity calorie consumption, but in this case, inference is made only for an estimated value of the calorie consumption.

Calorie is calculated with a total calorie intake and total calorie consumption. The calorie intake is performed only through inflow from the outside like food, but the total calorie consumption includes various elements. Typically, a necessary Total Metabolic Rate (TMR) is configured with a Basal Metabolic Rate (BMR) or Resting Metabolic Rate (RMR) that is basic energy metabolism necessary for maintaining life processes, Thermic Effect of Exercise (TEE) corresponding to energy metabolism necessary for physical activity, Thermic Effect of Food (TEF) used as energy necessary for intake and digestion foods and metabolism, and Adaptive Thermogenesis (AT) necessary for coping with an external temperature and stress.

However, these rates of children and teenagers in growth period may be greatly different from those of adults who have stopped growing. In addition, since activities thereof are greater than those of the adults, accurate estimation of the activity calorie consumption may not influence the total calorie consumption.

### SUMMARY

The present disclosure provides an activity monitoring system capable of more accurately measuring calorie and a method for measuring calorie consumption thereof.

An embodiment of the inventive concept provides a method for measuring calorie consumption of an activity monitoring system. The method includes: collecting calorie consumption data from at least one sensor worn by a user; classifying an activity type of the user corresponding to the calorie consumption data; classifying an intensity of the activity type; and calculating calorie consumption corresponding to the intensity of the activity type.

In an embodiment, the at least one sensor may include an acceleration sensor.

In an embodiment, the classifying of the activity type may include: analyzing the calorie consumption data to derive features; and utilizing the features as inputs of machine learning to determine a basis activity.

In an embodiment, the classifying of the intensity of the activity type may include classifying the basis activity into that having at least two intensities.

In an embodiment, the calculating of the calorie consumption may include estimating calorie consumption corresponding to the classified intensity of the basis activity.

In an embodiment, the machine learning may be performed through an artificial neural network.

In an embodiment, the method may further include estimating calorie of food to be taken in through an image sensor.

In an embodiment, the estimating of the calorie of food to be taken in may include: classifying the food to be taken in; estimating an intake of the classified food; and calculating a calorie corresponding to the estimated intake.

In an embodiment, the method may further include: digitally processing the calorie consumption data; and storing the digitally processed data.

In an embodiment, the method may further include transmitting the calorie consumption data to an external server.

In an embodiment, the method may further include: storing the calorie consumption data by using big data and deep learning; and recognizing a user pattern by using the stored data.

In an embodiment, the method may further include classifying activity types diversely according to an activity aspect of the user so as to adapt to a change in activity type of the user, when a new movement of the user occurs.

In an embodiment, an activity monitoring system includes: a sensor unit comprising a plurality of sensors coupled to a user; a digital processing unit configured to process data collected from the sensor unit; a storage unit configured to store the processed data; and a state display unit configured to display a user state according to a processing result of the digital processing unit, wherein the digital processing unit classifies a basis activity corresponding to the calorie consumption data by using an artificial neural network, determines an intensity of the basis activity, and estimate calorie consumption corresponding to the intensity of the basis activity.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram of an exemplary activity monitoring system according to an embodiment of the inventive concept;

FIG. 2 illustrates an exemplary artificial neural network as an embodiment of an algorithm according to an embodiment of the inventive concept;

FIG. 3 illustrates an exemplary 3-stage artificial neural network of an algorithm according to an embodiment of the inventive concept;

FIG. 4 illustrates exemplary input features to be used for an artificial neural network according to an embodiment of the inventive concept; and

FIG. 5 illustrates an exemplary method for measuring calorie consumption of an activity monitoring system according to an embodiment of the inventive concept.

### DETAILED DESCRIPTION

Hereinafter, an exemplary embodiment of the present invention will be described in detail with reference to the accompanying drawings such that a person skilled in the art may easily carry out the embodiments of the present invention.

The present disclosure may be variously modified and realized in various forms, and thus specific embodiments will be exemplified in the drawings and described in detail hereinbelow. However, the present invention is not limited to the specific disclosed forms, and needs to be construed to include all modifications, equivalents, or replacements included in the spirit and technical range of the present invention.

It will be understood that, although the terms first, second, etc. may be used herein to describe various elements, these elements should not be limited by these terms. These terms are only used to distinguish one element from another element. Thus, a first element discussed below could be termed a second element without departing from the teachings of the inventive concept.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion, e.g., “between” versus “directly between”, “adjacent” versus “directly adjacent”, etc.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, components or combinations thereof, but do not preclude the presence or addition of one or more other features, integers, steps, operations, elements, components, or combinations thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

An activity monitoring system and a method for measuring calorie consumption thereof according to an embodiment of the inventive concept may obtain signals from sensors such as an acceleration sensor, detect an activity type from the signals and record the activity type, and estimate activity calorie consumption therefrom. Accordingly, more information may be provided through the recording of the activity type and also more accurate calorie consumption may be estimated.

In particular, unlike adults whose calorie consumptions are stabilized, children and teenagers in growth period may be greatly differed according to an age group (a growth stage). Accordingly, not only calculating calorie consumption but also recording an activity type may be greatly helpful to a user. Since there's a great deal of variability between individuals, it is very difficult to accurately measure the calorie consumption. Even if the measured results are not correct, when information on what exercise is done and how the exercise is done is provided, since the user may perform relative analysis on movement patterns according to dates, the user may be assisted without depending on numerical values.

In addition, an activity monitoring system according to an embodiment of the inventive concept may include physical quantity sensors such as an acceleration sensor, which is attached to a point in a wearable type. As the wearable type, a hat, glasses, a belt, a shoe, or clothes, etc., are allowable, and in this case, physical quantity sensors may be realized to conveniently detect an activity type and estimate activity calorie consumption in order to measure daily life without wearing separate equipment. An activity monitoring system according to an embodiment of the inventive concept may be realized, for accuracy in calorie consumption, to combine a plurality of physical quantity sensors to utilize the combined result as an input of an algorithm for detecting an activity type.

On the other hand, an activity monitoring system according to an embodiment of the inventive concept may be realized to cope with a new movement and improve existing movement measuring accuracy by collecting user data. To this end, a sensor module of the activity monitoring system may store user movements to perform predetermined functions (e.g. activity type detection and estimation of activity calorie consumption, etc.) and at the same time persistently collect the stored data to accumulate data of an individual.

In an embodiment, when using big data and dip learning, user's individual data is continuously accumulated and an activity monitoring system may recognize a user pattern better. In addition, when a new movement occurs, the activity monitoring system may be realized to adapt to an activity type change of a user by diversifying classification of activity types according to an aspect of user activity.

An activity monitoring system according to an embodiment of the inventive concept may include a wearable/attachable device for basically performing a function of classifying activity types and estimating activity calorie consumption caused by activity.

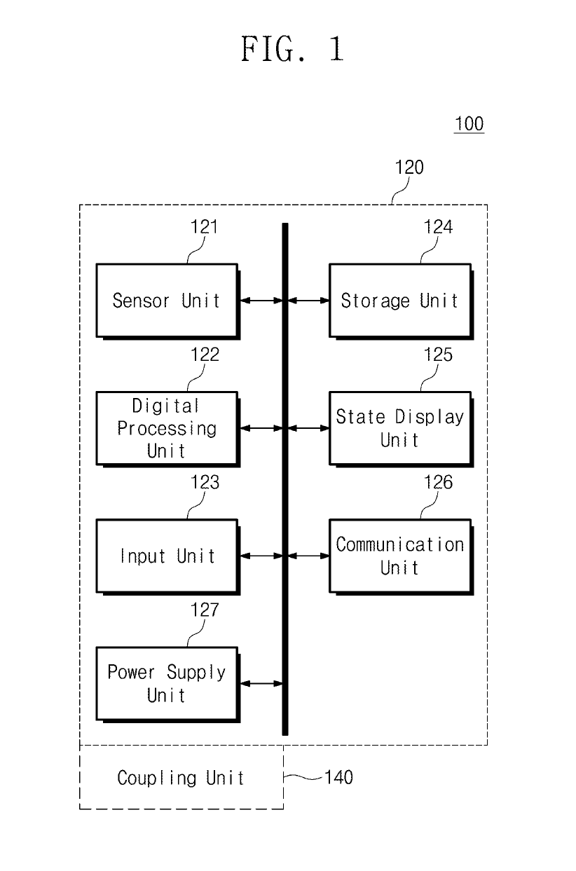

FIG. 1 is a block diagram of an exemplary activity monitoring system according to an embodiment of the inventive concept. Referring to FIG. 1, an activity monitoring system 100 may include a main body 120 and a coupling unit 140 for coupling the main body to a user body.

The main body 120 may include a sensor unit 121, a digital processing unit 122, an input unit 123, a storage unit 124, a state display unit 125, a communication unit 126, and a power supply unit 127.

The sensor unit 121 may include a plurality of physical quantity sensors attachable to the user body. In an embodiment, the sensor unit 121 may be realized in about 1.5 to about 6 g, 3-axis, and an analog type.

In an embodiment, the sensor unit 121 may include sensors necessary for detecting movements. For example, the sensor unit 121 may be obtained by combining an acceleration sensor with an auxiliary means such as a gyro sensor, temperature sensor, or altitude sensor.

In addition, these sensors may be available in plurality as attached to a body or clothes in an accessory type.

Examples of a wearing position and type of the sensors are as Table 1 below.

TABLE 1

| Position | Wearing type |
|---|---|
| Waist | standalone wearable type or inside a buckle of belt, etc. |
| Wrist | standalone wearable type or integral watch type, wrist |
| (arm, hand) | band type, bracelet type, ring type, etc. |
| Ankle (foot) | standalone wearable type or sock and shoe coupling type, |
| | insole type, etc. |
| Head | glasses (attached type or frame-inserted type, integral glass |
| | type, etc.), fixer of a hairpin type, accessory of an earring/ |
| | ear clip type, earphone/headphone type (inserted type |
| | or externally coupled type) |
| Clothes | top/bottoms (cloth-attached type or integral clothes |
| | type, cloth-inserted type, etc.) |
| Stand-along | wallet-insertable card type, wallet insertion type |
| type | (integral type), wearable on a body/clothes of a button or |
| | brooch type |

The digital processing unit 122 may be realized to process a signal measured from the physical quantity sensors. For example, the digital processing unit 122 may be realized to include MSP43 (TI). For example the digital processing unit 122 may be realized to include a 12 bit analog-to-digital converter which consumes low power.

The input unit 123 may be realized to receive a specific input from a user. For example, the input unit 123 may be realized with two input switches.

The storage unit 124 may be realized to store measured data and collected data.

The state display unit 125 may be realized to display a state to a user. For example, the state display unit 125 may be configured with 4 light emitting diodes (LEDs).

The communication unit 126 may be realized to communicate in a wired/wireless manner with an external device. For example, the communication unit 126 may be realized to perform USB communication.

The power supply unit 127 may be realized to supply power to components inside the activity monitoring system 100 or to charge power thereto. In an embodiment, the power supply unit 127 may include a battery. For example, the power supply unit 127 may be realized with a Li-Polymer battery. In an embodiment, the power supply unit 127 may include a battery charging unit for charging a battery.

The coupling unit 140 may be realized such that a user wears or inserts the activity monitoring system 100. For example, the coupling unit 140 may be realized with a clip or Velcro band.

In addition, a sampling rate of the activity monitoring system according to the inventive concept may be differed according to a situation (e.g. a user activity type) to reduce a data amount and power consumption. For example, when the user is detected as being sat, the sampling rate may be lowered until the user is detected to stand up again due to a decrease in activity.

On the other hand, an operation method (i.e. algorithm) of the activity monitoring system 100 of the inventive concept is as follows.

An algorithm for estimating an activity type may provide a higher-level activity record to a user by applying a scheme in which estimation is performed in two steps of a basis activity and the activity type, and applying, to a user, a method for estimating sports beyond an activity such as walking or running.

The basis activity is a basic activity element, which is a daily-life movement, and may be represented as the following examples. The basis activity may be defined as the following Table 2.

TABLE 2

| mark | basis activity | Note |
|---|---|---|
| a0 | lying | most convenient posture like sleeping |
| a1 | sitting | sitting on a chair |
| a2 | standing | |
| a3 | turning back | left/right, 90°/180°/360° |
| a4 | walking | slow/fast (individually convenient speed) |
| a5 | running | slow/fast (individually convenient speed) |
| a6 | stairs ascending | by walking/running |
| a7 | stairs descending | by walking/running |
| a8 | standing jump | |
| an | etc. | extendable to other activity element |

Activity types may be defined as follows by using the above-described basis activities. The activity types may indicate types of activities configured with a combination of elements defined in the basis activities. For example, definitions as follows are available. A1={ . . . , a4, a3, a8, . . . , a4, a5, . . . , a8, . . . } may be classified into basketball. A2, A3, A4, . . . etc., may be conjectured as an activity type such as soccer or jogging.

In addition, an algorithm for estimating an activity type according to the inventive concept may estimate calorie consumption for the basis activity through classification for the basis activity. This activity type may be estimated through comparison with experiment data obtained in advance through experiments or by referring to a metabolic equivalent of task (MET).

On the other hand, an algorithm according to an embodiment of the inventive concept may use machine learning. For example, the machine learning may be performed with an artificial neural network.

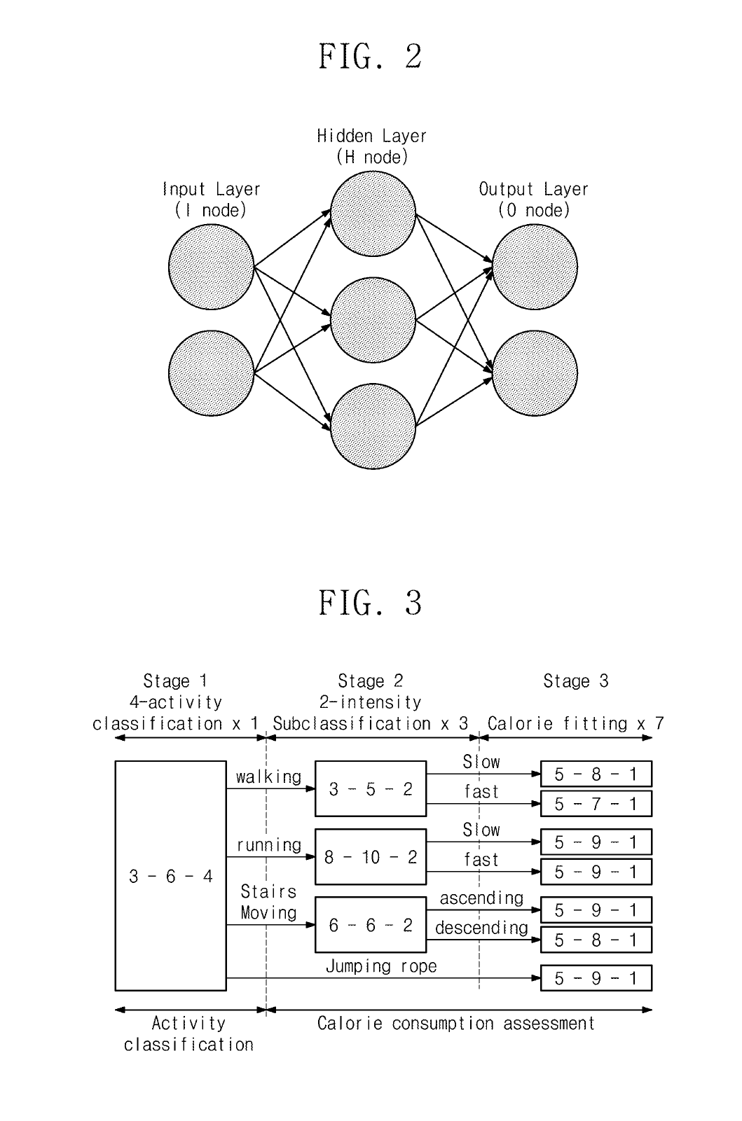

FIG. 2 illustrates an exemplary artificial neural network as an embodiment of an algorithm according to an embodiment of the inventive concept. Referring to FIG. 2, firstly, acceleration data, which is obtained through experiments for identifying each basis activity, is analyzed to extract features, uses the features as inputs of the artificial neural network, and an output thereof may be defined as a basis activity desired to determine. In addition, the optimal number of nodes of a hidden layer may be determined to drive an optimized result.

FIG. 3 illustrates an exemplary 3-stage artificial neural network of an algorithm according to an embodiment of the inventive concept. Referring to FIG. 3, stage 1 may be realized with input nodes configured with three features, 6 hidden layer nodes, and output nodes configured with 4 basis activities. In an embodiment, the 4 basis activities may be walking, running, stairs moving, and standing jump (represented as jumping rope in the drawing). The activity calorie consumption may be estimated with these, and in case of having a large activity variation, since the activity calorie consumption has a very large value range, it may be difficult to measure accurately.

Stage 2 may include sub-classifications in which walking is sub-classified into slow walking and fast walking, running is sub-classified into slow running and fast running, and stairs moving are sub-classified into ascending and descending. When sub-classified in this way, a distribution range of an activity calorie consumption value (a calorie measurement value) obtained through experiments becomes narrow and an accurate measurement value may be calculated.

In stage 3, each activity calorie consumption value is applied to the foregoing sub-classified activity type to perform data fitting, and as a result, user's activity calorie consumption may be finally provided.

Accordingly, the activity type provision in stage 1, the sub-classified activity type provision in stage 2, and improvement in accuracy of calorie consumption for each activity type in stage 3 are enabled.

There are various candidates of input features to be used in the artificial neural network.

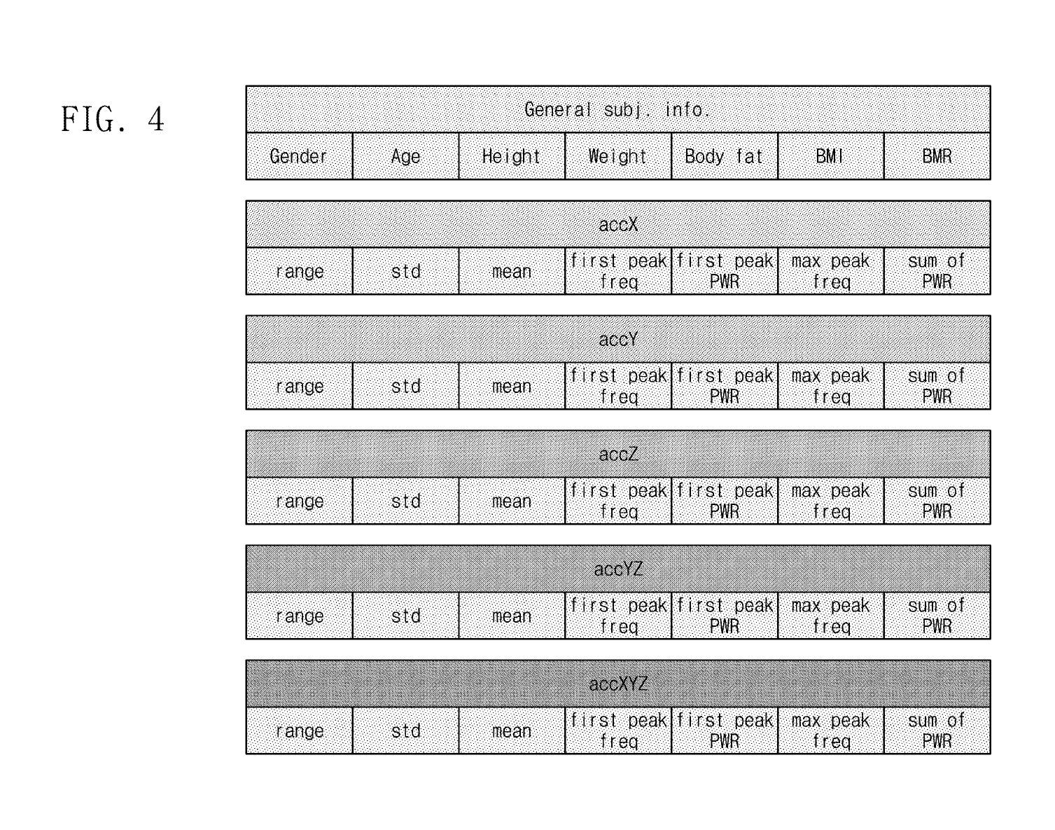

FIG. 4 illustrates exemplary input features to be used for an artificial neural network according to an embodiment of the inventive concept. Referring to FIG. 4, accX, accY, and accZ are 3-axis directions of an acceleration sensor, and accYZ and accXYZ are respectively sum vectors of corresponding axes. These features are just examples and are not limited thereto, and a lot more may be utilized when applied in reality.

An embodiment, in which features, hidden layer nodes, and classified activities of the inventive concept are arranged, may be represented as the following Table 3.

TABLE 3

| Network | | |
|---|---|---|
| I-H-O | Features for network input | Targets |
| Stage 1 | Range, std, sum of power (vertical | Walking, |
| Classification | axis) | Running, |
| 3-6-4 | | Stairs moving, |
| | | Jumping rope |
| Stage 2-1 | std, 1st peak freq, max peak | Walking slow, |
| Classification | freq (vertical axis) | walking fast |
| 3-5-2 | | |
| Stage 2-2 | Range, std, sum of power | Running slow, |
| Classification | (vertical axis) // | Running fast |
| 8-10-2 | Mean, sum of power (sagittal axis) // | |
| | std (vector sum of transverse and | |
| | sagittal axis by here) // | |
| | std, sum of power (vector | |
| | sum of all 3 axes) | |
| State 2-3 | std, 1st peak freq, 1st peak power, | Stairs ascending, |
| Classification | max peak freq, sum of power | Stairs descending |
| 6-6-2 | (vertical axis)// | |
| | std(transverse axis) | |
| Stage 3 | Range, std, sum of power | Consumed |
| Data fitting | (vertical axis) // | calories |
| 5-H(7~9)-1 | std, sum of power | (for each activity) |
| | (vector sum of all 3 axes) | |

A result according to the foregoing embodiment may be arranged as the following Table 4. Table 4 is a result for activity classification in which 4 basis activities in stage 1 are classified.

TABLE 4

| | Actual Activity (Target) | | | |
|---|---|---|---|---|
| Network | 1 | 2 | 3 | 4 |
| Output | walking | running | stairs moving | jumping rope |
| 1 | 95.97 | 4.03 | 1.61 | 1.61 |
| 2 | 0.81 | 93.55 | 0.81 | 8.06 |
| 3 | 3.23 | 0.81 | 96.77 | 0.00 |
| 4 | 0.00 | 1.61 | 0.81 | 90.32 |

Table 5 is a result of sub-classification of basis activities in stage 2.

TABLE 5

| | Stage | | | | | |
|---|---|---|---|---|---|---|
| | 2-1 | | 2-2 | | 2-3 | |
| | (walking) | | (running) | | (stairs) | |
| | Actual Activity (Target) | | | | | |
| Output | 1 = slow | 2 = fast | 1 = slow | 2 = fast | 1 = up | 2 = down |
| 1 | 88.71 | 14.52 | 88.71 | 20.97 | 93.55 | 9.68 |
| 2 | 11.29 | 85.48 | 11.29 | 79.03 | 6.45 | 90.32 |

Table 6 shows a comparison result between an estimation result of activity calorie consumption, when stages 1 to 3 are undergone, and an estimation result of activity calorie consumption with stage 2 omitted.

TABLE 6

| 3-Stage | 3-1 | 3-2 | 3-3 | 3-4 | 3-5 | 3-6 | 3-7 |
|---|---|---|---|---|---|---|---|
| # | 8 | 7 | 9 | 9 | 9 | 8 | 9 |
| mse | 0.83 | 1.61 | 3.44 | 7.40 | 1.68 | 0.62 | 10.45 |
| error rate | 13.72 | 15.51 | 14.51 | 18.70 | 23.58 | 25.62 | 14.97 |

| 2-Stage | 3-1 & 3-2 | 3-3 & 3-4 | 3-5 & 3-6 | 3-7 |
|---|---|---|---|---|
| # | 10 | 8 | 16 | 9 |
| mse | 1.85 | 8.49 | 2.02 | 10.45 |
| error rate | 18.05 | 21.24 | 26.78 | 14.97 |

In addition, an activity monitoring system of the inventive concept may estimate a calorie intake. As an embodiment, an image sensor may be utilized as a sensor for the estimation and may exist at a hinge part, at which a temple of glasses is folded, to collect information in line of sight. In this case, there is a method for finding absolute calorie of food and a method for estimating relative calorie thereof.

Firstly, when estimating the absolute calorie, food types are collected from an image sensor and are identified with an image processing manner. As an embodiment, there is a classification method in which many images are obtained and learning is performed through a deep learning method, etc., to identify similar kinds of foods. In addition, since it may be found how much food is taken in at a point to which a hand, chopsticks, or a fork is headed, how much food a user takes may be found even if many people have a meal together. When classification (e.g. Korean food/rice) of ingests is enabled with the following example, it is possible to estimate an intake when intake information is added. Although it may be better to have more detailed information, since estimation of calorie intake is possible only with a certain degree of classification and intake measurement, it is accessible with an intake estimation method for efficient use.

Korean food: Rice (plain white rice, multi-grain rice, barley rice, etc.), greens (various green-leaf vegetables, bean sprouts, etc.), Kimchi (cabbage kimchi, watery kimchi, radish water kimchi, young radish kimchi, etc.), soup (various soups), meat (Bulgogi, ribs, soy sauce braised beef, stir-fried spicy pork, chicken, etc.), other protein (bean, egg, milk, etc.), porridge (abalone rice porridge, pumpkin porridge, etc.)

Western food: steak (various steaks), salads (check whether to contain meat), soups (various soups), desserts (various desserts such as a cake, an ice cream, etc.), pizzas (various pizzas)

Alcohol: spirituous liquor (alcohol containing high alcohol such as whisky, brandy, vodka, or kaoliang liquor), wine (alcohol containing moderate alcohol of various wines such as red, white, sparkling, etc.), traditional alcohol (alcohol such as unrefined rice wine), beer (various beers)

Snacks: snack foods, chocolates, candies

Various beverages: soda (cola, cider, etc.), fruit based drinks (orange juice, etc.), tea (coffee, green tea, etc.), other beverages (various sport drinks, energy drinks, etc.), mineral water (mineral water, tonic water, etc.)

On the other hand, each sensor of an activity monitoring system according to an embodiment of the inventive concept may provide a storage space in which acceleration is recordable, and activity types or activity calorie consumption from the stored acceleration through the foregoing method. At this point, data that is obtained from the sensor unit, such as data from the recorded activity or data about an environment, may be stored in the storage unit through a digital processing unit. In addition, the data may be transmitted to a user terminal in a wired/wireless manner through a communication unit. Here, the terminal may be a smartphone or user PC, etc. In addition, the data may also be transmitted to a central server of a main body for providing services.

Firstly, the user terminal collects user data to make a kind of big data. For example, a deep learning method may show a better result by using both of a non-supervising learning method and a supervised learning method. Accordingly, when the user data is persistently accumulated and utilized for learning, an activity monitoring system of the inventive concept may be evolved to more accurate measurement system.

In addition, when the user data is secured and an activity type, which is different from existing basis activities, is found through a clustering method such as a self organizing map (SOM), the activity type may be transmitted to the central server. Such a service subject may analyze the new activity type and add the same to the basis activities. In addition, a basis activity type in a user device may be added by a network-based program update method through the user terminal.

Moreover, the collected user data may be transmitted from the user terminal to the central server, and the central server may use the same for analyzing various user data to estimate an activity type and improve an algorithm for activity calorie consumption.

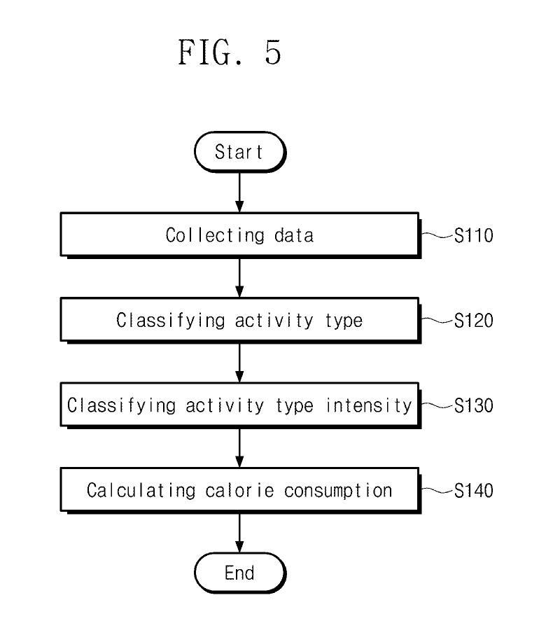

FIG. 5 illustrates an exemplary method for measuring calorie consumption of an activity monitoring system according to an embodiment of the inventive concept. Referring to FIGS. 1 to 5, a method of measuring calorie consumption of the activity monitoring system 100 is as follows.

User data may be collected from at least one sensor configuring the sensor unit 121 of the activity monitoring system 100 (operation S110). In an embodiment, data collection may be performed periodically or non-periodically. In an embodiment, the data collection may be performed in response to a user request or according to own policy.

User activities, which correspond to the calorie consumption data, may be classified on the basis of a prescribed algorithm (operation S120). For example, as illustrated in FIG. 3, a plurality of basis activities (e.g. walking, jumping, stairs moving, running, etc.) through an artificial neural network.

Thereafter, intensities of the classified basis activities may be classified on the basis of a prescribed algorithm (operation S130). For example, as illustrated in FIG. 3, fast walking and slow walking, fast running and slow running, or stairs ascending and stairs descending, etc., may be classified in detail.

Thereafter, activity calorie consumption may be calculated in correspondence to the sub-classified user activity types.

The method for measuring calorie consumption of the activity monitoring system 100 of the inventive concept may measure more accurate calorie consumption by classifying the activity types in more detail and calculating calorie consumption thereof.

An activity monitoring system and a method for measuring calorie consumption thereof according to an embodiment of the inventive concept may obtain signals from sensors such as an acceleration sensor, detect an activity type from the signals and record the activity type, and estimate activity calorie consumption therefrom. Accordingly, more information may be provided through the recording of the activity type and also more accurate calorie consumption may be estimated.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A method for measuring calorie consumption in an activity monitoring system, comprising:
collecting calorie consumption data from at least one sensor worn by a user;
classifying an activity type of the user corresponding to the calorie consumption data;
classifying an intensity of the activity type; and
calculating calorie consumption corresponding to the intensity of the activity type.

2. The method of claim 1, wherein the at least one sensor comprises an acceleration sensor.

3. The method of claim 1, wherein the classifying of the activity type comprises:
deriving features by analyzing the calorie consumption data; and
determining a basis activity by utilizing the features as inputs of machine learning.

4. The method of claim 3, wherein the classifying of the intensity of the activity type comprises
classifying the basis activity into that having at least two intensities.

5. The method of claim 4, wherein the calculating of the calorie consumption comprises estimating calorie consumption corresponding to the classified intensity of the basis activity.

6. The method of claim 4, wherein the machine learning is performed through an artificial neural network.

7. The method of claim 1, further comprising: estimating calorie of food to be taken in through an image sensor.

8. The method of claim 7, wherein the estimating of the calorie of food to be taken in comprises:
classifying the food to be taken in;
estimating an intake of the classified food; and
calculating a calorie corresponding to the estimated intake.

9. The method of claim 1, further comprising:
digitally processing the calorie consumption data; and
storing the digitally processed data.

10. The method of claim 1, further comprising:
transmitting the calorie consumption data to an external server.

11. The method of claim 1, further comprising:
storing the calorie consumption data by using big data and deep learning; and
recognizing a user pattern by using the stored data.

12. The method of claim 11, further comprising:
classifying activity types diversely according to an activity aspect of the user so as to adapt to a change in activity type of the user, when a new movement of the user occurs.

13. The method of claim 1, wherein a sample rate is differed according to the activity type of the user.

14. An activity monitoring system comprising:
a sensor unit comprising a plurality of sensors coupled to a user;
a digital processing unit configured to process data collected from the sensor unit;
a storage unit configured to store the processed data; and
a state display unit configured to display a user state according to a processing result of the digital processing unit,
wherein the digital processing unit classifies a basis activity corresponding to the calorie consumption data by using an artificial neural network, determines an intensity of the basis activity, and estimate calorie consumption corresponding to the intensity of the basis activity.
